(19) United States
(12) Patent Application Publication
(10) Pub. No.: US 2014/0145832 A1
(43) Pub. Date: May 29, 2014

(54) RFID TAG INCLUDING MULTI-VOLTAGE MULTIPLIERS AND OPERATING METHOD THEREOF

(71) Applicant: Electronics and Telecommunications Research Institute, Daejeon-si (KR)

(72) Inventors: Hyunseok KIM, Jeollabuk-do (KR); Heyung Sub Lee, Daejeon-si (KR); Chan-Won Park, Daejeon-si (KR)

(21) Appl. No.: 13/943,479

(22) Filed: Jul. 16, 2013

(30) Foreign Application Priority Data
Nov. 23, 2012 (KR) 10-2012-0133973

(51) Int. Cl. G06K 7/10

(52) U.S. Cl. CPC G06K 7/10158
USPC 340/10.5

(57) ABSTRACT

There is provided an RFID tag having multi-voltage multipliers including two or more antennas configured to receive electromagnetic waves emitted from a reader, a first voltage multiplier configured to be connected to one of the antennas and change the received AC electromagnetic waves to DC voltage signals, a modulator configured to transmit backscattering communication signals by changing impedance through the antenna connected to the first voltage multiplier, and a second voltage multiplier configured to be connected to another antenna among the antennas and change AC electromagnetic waves received from the other antenna to DC voltage signals.

### CROSS-REFERENCE TO RELATED APPLICATION

This application claims the benefit under 35 U.S.C. § 119(a) of Korean Patent Application No. 10-2012-0133973, filed on Nov. 23, 2012, the entire disclosure of which is incorporated herein by reference for all purposes.

### BACKGROUND

1. Field

The following description relates to a radio frequency identification tag, and more particularly, to a structure of a voltage multiplier that changes radio signals received from a reader to voltage signals.

2. Description of the Related Art

Radio frequency identification (RFID) is technology for reading information included in a tag and recording the information in the tag using radio frequency (RF), and is used to identify, track, and manage, for example, tagged objects, animals or people. The RFID system has unique identification information and includes, for example, a tag or a transponder attached to an object, person, etc., a reader to read identification information included in the tag or to write information in the tag, a database (object database), and a network.

Securing price competitiveness is important for market scalability of the RFID system. For this purpose, the RFID tag needs to be massively produced at a low cost using a CMOS process. Moreover, since a reading range of the RFID tag is important to the RFID system for its market competitiveness, technology capable of obtaining a stable effective operation range even at low input power is necessary.

### SUMMARY

The following description relates to an RFID tag device capable of obtaining a stable effective operation range with low power consumption and an operating method thereof.

In one general aspect, an RFID tag having multi-voltage multipliers includes two or more antennas configured to receive electromagnetic waves emitted from a reader, a first voltage multiplier configured to be connected to one of the antennas and change the received AC electromagnetic waves to DC voltage signals, a modulator configured to transmit backscattering communication signals by changing impedance through the antenna connected to the first voltage multiplier, and a second voltage multiplier configured to be connected to another antenna among the antennas and change AC electromagnetic waves received from the other antenna to DC voltage signals.

In another aspect, a method of transmitting and receiving using multi-voltage multipliers in an RFID tag includes determining whether modulated signals are transmitted, transmitting backscattering communication signals to a reader through an antenna connected to a voltage multiplier by modulating signals when the modulated signals are transmitted, and changing AC signals received from the reader through each of one or more other antennas to DC voltage signals through each of one or more other voltage multipliers.

Other features and aspects will be apparent from the following detailed description, the drawings, and the claims.

### BRIEF DESCRIPTION OF THE DRAWINGS

FIG. 1 is a diagram illustrating a structure of a general RFID tag.

FIG. 2 is a diagram illustrating a relation between output voltages of a voltage multiplier in the tag and communication signals between a reader and the tag.

FIG. 3 is a diagram illustrating a structure of a general RFID tag.

FIG. 4 is a diagram illustrating changes of output voltages of the voltage multiplier in the tag illustrated in FIGS. 1 and 3.

FIG. 5 is a diagram illustrating a structure of an RFID tag including multi-voltage multipliers according to an embodiment of the invention.

FIG. 6 is a comparison graph illustrating changes of voltages stored in a capacitor according to power received from the reader through the voltage multiplier according to the embodiment of the invention.

FIG. 7 is a diagram illustrating an operating method in the RFID tag including the multi-voltage multipliers according to the embodiment of the invention.

Throughout the drawings and the detailed description, unless otherwise described, the is same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, exemplary embodiments of the invention will be described in detail with reference to the accompanying drawings. The following embodiments should be considered in a descriptive sense only in order to understand of the spirit of the invention and the scope of the invention is not limited to the exemplary embodiments.

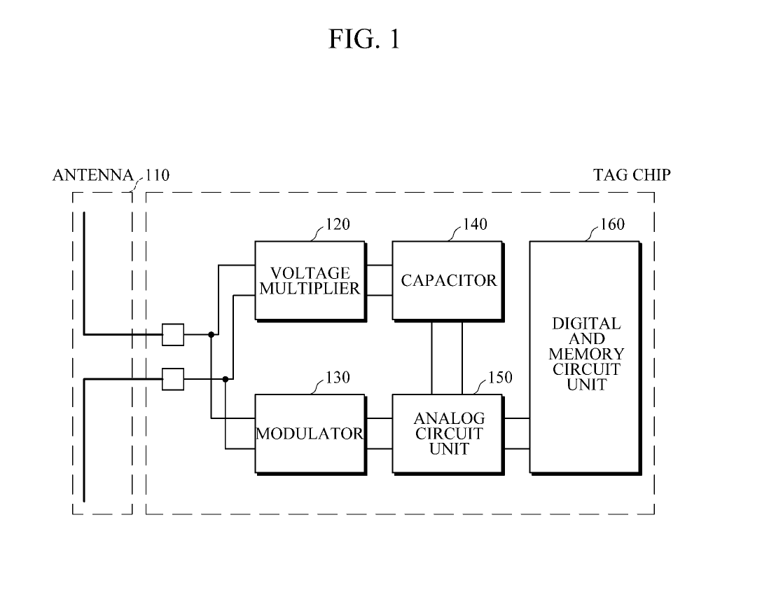

FIG. 1 is a diagram illustrating a structure of a general RFID tag.

As illustrated in FIG. 1, an antenna 110 receives electromagnetic waves emitted from a reader. A voltage multiplier 120 and a modulator 130 are connected to a terminal of the antenna 110.

The voltage multiplier 120 changes wireless power transmitted from the reader through the antenna 110, that is, AC power, to power necessary to operate an RFID tag chip, that is, DC power. The signal changed to the DC power by the voltage multiplier 120 is stored in a capacitor 140, and is used in an analog circuit unit 150 and a digital and memory circuit unit 160.

The modulator 130 generates signals generated in the digital and memory circuit unit 160 as backscattering communication signals by changing impedance of the tag chip through the analog circuit unit 150. Those signals are transmitted to the reader through the antenna 110. The above-described structure of the RFID tag is employed in all tag chips commonly used in the current market.

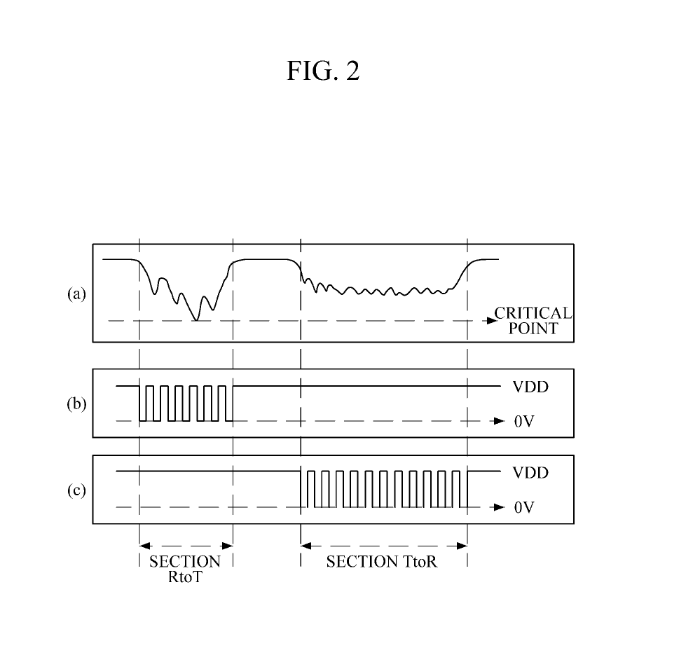

Power received from the reader through the voltage multiplier 120 is the most important factor to determine a reading range between the reader and the tag. However, since the voltage multiplier 120 and the modulator 130 are connected to one antenna 110, the power received from the reader through the voltage multiplier 120 is minimized while the modulator 130 operates and signals are transmitted to the reader. Therefore, this structure has a problem in that the reading range decreases. FIG. 2 is a graph illustrating variations of voltages stored in the capacitor according to the power received from the reader through the voltage multiplier.

As illustrated in FIG. 2, (b) is a graph of changing signals received from the reader and (c) is a graph of changing signals transmitted to the reader. As illustrated in (b), the tag receives signals from the reader in a section RtoT, and as illustrated in (c), the tag transmits signals to the reader in a section TtoR.

(a) is a graph illustrating changes of maximum voltages of the capacitor. In the section RtoT, output voltages of the voltage multiplier 120, that is, maximum voltages of a storage capacitor, decrease according to strength signals of RF power. In addition, in the section TtoR, output voltages of the voltage multiplier 120, that is, the maximum voltages of the storage capacitor, also decrease.

At this time, the reading range between the reader and the tag is generally determined based on whether power capable of operating the tag itself can be generated. When the output voltage of the voltage multiplier is lower than a critical point, a reset signal is off and communication is terminated. Therefore, the RF power received from the reader needs to be increased in order for the output voltage of the voltage multiplier to be more than the critical point. For this purpose, a method of, for example, increasing an antenna yield of the reader or the tag, decreasing a distance between the reader and the tag, or increasing efficiency of the voltage multiplier of the tag, may be possible.

Meanwhile, in general, a case in which the output voltage of the voltage multiplier is equal to or lower than the critical point is more likely to occur in the section RtoT than in the section TtoR. This is because it is difficult to perfectly implement the backscattering method in the tag and commercial readers have a very good receiving sensitivity.

In order to increase the output voltage of the voltage multiplier in the section RtoT, a method using two antennas is possible.

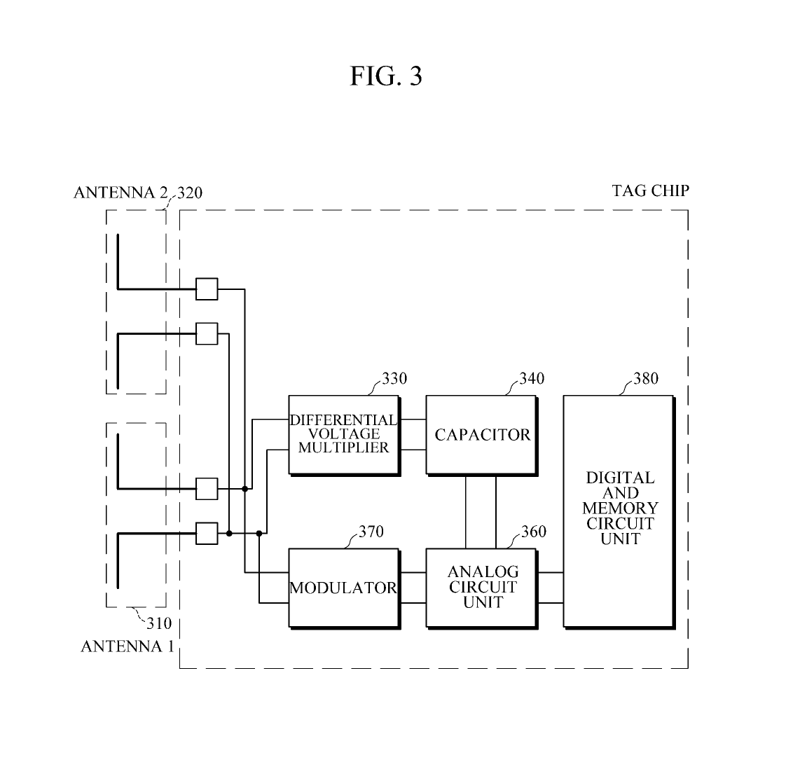

FIG. 3 is a diagram illustrating a structure of an RFID tag using two antennas.

As illustrated in FIG. 3, the RFID tag includes two or more antennas 310 and 320 to receive electromagnetic waves emitted from the reader and one differential voltage multiplier 330.

The differential voltage multiplier 330 is connected to all the antennas 310 and 320 and changes the received AC electromagnetic waves to DC voltage signals. Output of the differential voltage multiplier 330 is stored in a capacitor 340. Accordingly, it is possible to increase receiving power compared to conventional methods using one antenna.

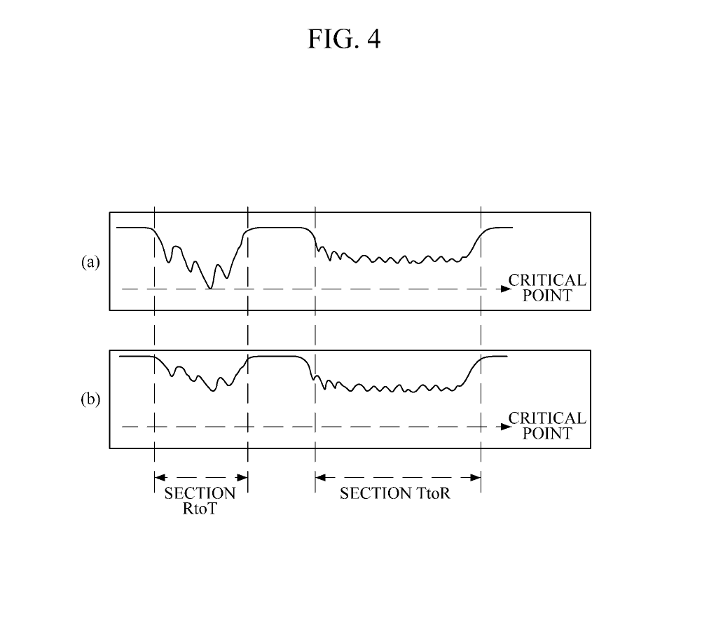

FIG. 4 is comparison graph illustrating changes of voltages stored in the capacitor according to the power received from the reader through the voltage multiplier.

As illustrated in FIG. 4, (a) is a graph illustrating variations of voltages stored in the capacitor according to the power received from the reader through the voltage multiplier in the RFID tag illustrated in FIG. 1 and (b) is a graph illustrating variations of voltages stored in the capacitor according to the power received from the reader through the voltage multiplier in the RFID tag illustrated in FIG. 3.

Comparing (a) and (b), it is understood that the output voltage of the voltage multiplier in a section RtoT increases when two antennas are used. However, since the backscattering occurs in the two antennas, performance is not significantly increased in a section TtoR. Therefore, a case in which the output voltage of the voltage multiplier is equal to or lower than the critical point may occur in both the section TtoR and the section RtoT. In order to address the above-mentioned problems of the RFID tag, the invention provides a structure including two or more voltage multipliers and two or more antennas.

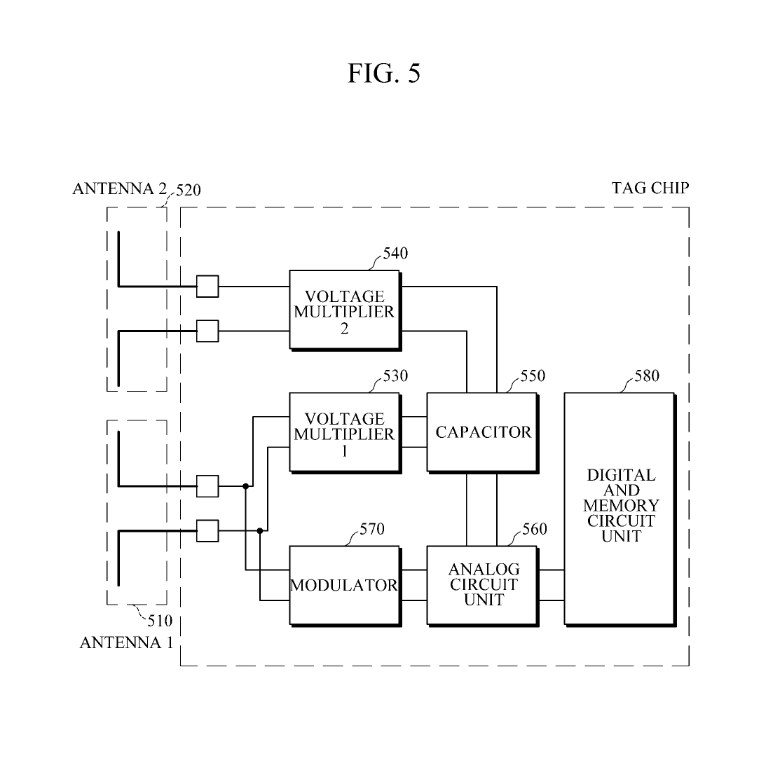

FIG. 5 is a diagram illustrating a structure of an RFID tag including multi-voltage multipliers according to an embodiment of the invention.

As illustrated in FIG. 5, according to the embodiment of the invention, the RFID tag includes two or more antennas 510 and 520 to receive electromagnetic waves emitted from the reader and voltage multipliers 530 and 540. Although two antennas are illustrated in FIG. 5, this is only an example, and the invention is not limited thereto. That is, three or more antennas may be included.

The first voltage multiplier 530 is connected to either one 510 of the antennas 510 and 520 and changes the received AC electromagnetic waves to DC voltage signals. The second voltage multiplier 540 is connected to the other 520 of the antennas 510 and 520 and changes AC electromagnetic waves received from the other antenna 520 to DC voltage signals. Outputs of the two or more voltage multipliers 530 and 540 are stored in one capacitor 550. The power stored in the capacitor 550 is used in an analog circuit unit 560. Although two voltage multipliers are illustrated in FIG. 5, this is only an example, and the invention is not limited thereto. That is, three or more voltage multipliers may be included. A modulator 570 generates signals received from a digital and memory circuit unit 580 through the analog circuit unit 560 as backscattering communication signals by changing the impedance through the antenna 510 connected to the first voltage multiplier 530 and transmits the signals to the reader.

According to the embodiment of the invention described above, when receiving signals from the reader, since signals received from each of the antennas 510 and 520 are changed to DC voltage signals by the first and second voltage multipliers 530 and 540 and then stored in the capacitor 550, voltages stored in the capacitor 550 are more than twice than the conventional methods using one antenna.

On the other hand, in transmitting signals to the reader, since the modulator 570 transmits signals through the antenna 510, the power received through the first voltage multiplier 530 connected to the antenna 510 is sharply decreased. However, since the second voltage multiplier 540 receives signals from the reader through the other antenna 520 to which the modulator 570 is not connected, received power is similar to the conventional methods using one antenna, that is, the power is received using one voltage multiplier. According to the invention, the reading range between the reader and the tag may be increased. When three or more antennas and three or more voltage multipliers are included, one antenna is connected to the first voltage multiplier and the modulator, the remaining two or more antennas are respectively connected to the remaining two or more voltage multipliers, and power may be stored in the capacitor.

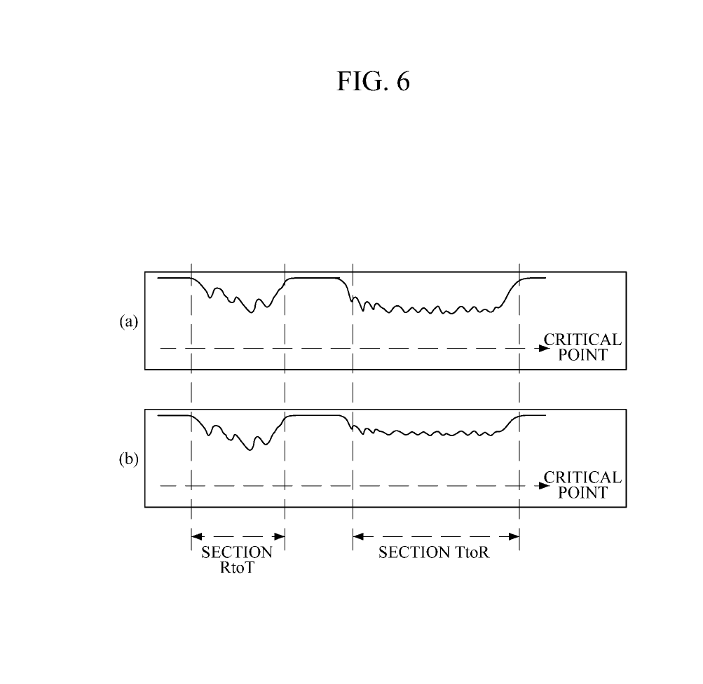

FIG. 6 is a comparison graph illustrating changes of voltages stored in the capacitor according to the power received from the reader through the voltage multiplier according to the embodiment of the invention.

As illustrated in FIG. 6, (a) is a graph illustrating variations of voltages stored in the capacitor according to the power received from the reader through the voltage multiplier in the RFID tag illustrated in FIG. 3, and (b) is a graph illustrating variations of voltages stored in the capacitor according to the power received from the reader through the voltage multiplier in the RFID tag illustrated in FIG. 5.

Comparing (a) and (b), it is understood that the output voltage of the voltage multiplier is increased not only in a section RtoT but also in a section TtoR. That is, it is understood that the section RtoT again serves as a factor for determining the receiving sensitivity of the tag.

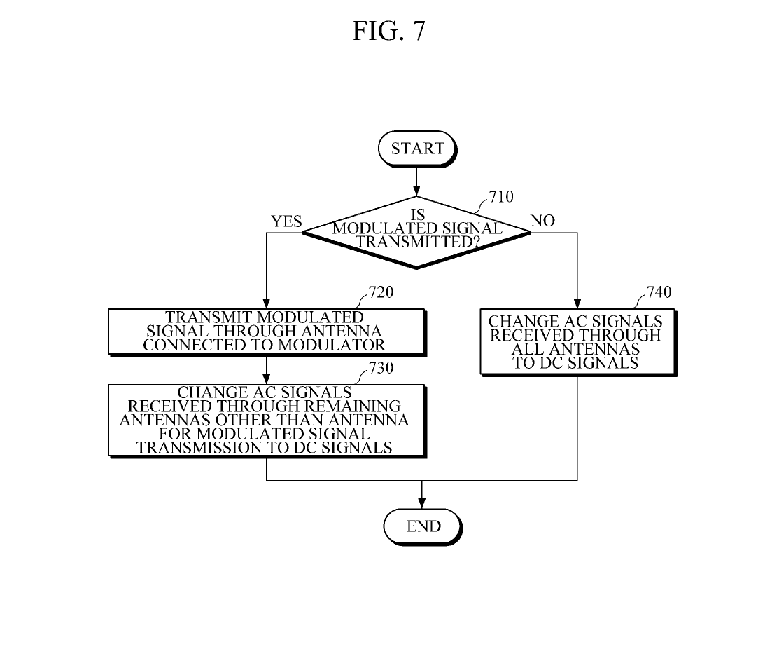

FIG. 7 is a diagram illustrating an operating method in the RFID tag including the multi-voltage multipliers according to the embodiment of the invention.

As illustrated in FIG. 7, the RFID tag determines whether modulated signals are transmitted in operation 710. That is, it determines whether signals transmitted from the tag to the reader are present.

When the determination result of operation 710 is that the modulated signals are transmitted, the RFID tag modulates signals received from the digital and memory circuit unit 580 in operation 720, generates backscattering communication signals by changing the impedance through the antenna 510 connected to the first voltage multiplier 530, and transmits the signals to the reader. Then, in operation 730, the second voltage multiplier 540 receives AC signals from the reader through the other antenna 520 to which the modulator 570 is not connected and changes the AC signals to DC signals.

On the other hand, when the determination result of operation 710 is that the modulated signals are not transmitted, the RFID tag receives AC signals transmitted from the reader through each of the antennas and changes the received AC signals to DC voltage signals through the voltage multipliers connected to each of the antennas in operation 740.

The RFID tag including multi-voltage multipliers of the invention may produce high DC output voltages compared to conventional voltage multipliers with respect to the same input power. Therefore, since desired DC output voltages are obtained even at low input power, it is possible to increase effective operation range.

The above-described descriptions are only exemplary embodiments of the invention. It will be understood by those skilled in the art that modifications in form may be made without departing from the spirit and scope of the invention. Therefore, the invention is not limited to the above-described embodiments and encompasses all modifications and equivalents that fall within the scope of the appended claims.

The present invention can be implemented as computer-readable code in a computer-readable recording medium. The computer-readable recording medium includes all types of recording media in which computer-readable data is stored. Examples of the computer-readable recording medium include a ROM, a RAM, a CD-ROM, a magnetic tape, a floppy disk, and an optical data storage. Further, the recording medium may be implemented in the form of carrier waves, such as those used in Internet transmission. In addition, the computer-readable recording medium may be distributed among computer systems over a network such that computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An RFID tag having multi-voltage multipliers comprising:
two or more antennas configured to receive electromagnetic waves emitted from a reader;
a first voltage multiplier configured to be connected to one of the antennas and change the received AC electromagnetic waves to DC voltage signals;
a modulator configured to transmit backscattering communication signals by changing impedance through the antenna connected to the first voltage multiplier; and
a second voltage multiplier configured to be connected to another antenna among the antennas and change AC electromagnetic waves received from the other antenna to DC voltage signals.

2. The RFID tag having multi-voltage multipliers according to claim 1, wherein the number of other antennas is two or more.

3. The RFID tag having multi-voltage multipliers according to claim 1, wherein the number of second voltage multipliers is two or more.

4. A method of transmitting and receiving using multi-voltage multipliers in an RFID tag comprising:
determining whether modulated signals are transmitted;
transmitting backscattering communication signals to a reader through an antenna connected to a voltage multiplier by modulating signals when the modulated signals are transmitted; and
changing AC signals received from the reader through each of one or more other antennas to DC voltage signals through each of one or more other voltage multipliers.

5. The method according to claim 4, further comprising changing AC signals received from the reader through each of the antennas to DC voltage signals through each of the voltage multipliers when the determination result is that the modulated signals are not transmitted.
